(19) United States
(12) Patent Application Publication
(10) Pub. No.: US 2020/0133645 A1
(43) Pub. Date: Apr. 30, 2020

(54) USER INTERFACE AND FRONT END APPLICATION AUTOMATIC GENERATION

(71) Applicant: JPMorgan Chase Bank, N.A., New York, NY (US)

(72) Inventor: Trevor D. JASKOT, Warrenton, VA (US)

(73) Assignee: JPMorgan Chase Bank, N.A., New York, NY (US)

(21) Appl. No.: 16/657,249

(22) Filed: Oct. 18, 2019

Related U.S. Application Data
(60) Provisional application No. 62/752,636, filed on Oct. 30, 2018.

(51) Int. Cl. G06F 8/38

(52) U.S. Cl. CPC G06F 8/38

(57) ABSTRACT

A method for generating a user interface for facilitating user interaction with a software application is provided. The method includes identifying an application; displaying, to a user, a list of selectable features; receiving user selections from the list; and automatically generating a user interface based on the identified application and the received user selections. As a result of the automatic generation of the user interface, command logic is generated and integrated into the user interface, thereby providing the user with an integration platform to be further connected with a database, back-end system, or network.

### CROSS-REFERENCE TO RELATED APPLICATION

This application claims the benefit of U.S. Provisional Patent Application Ser. No. 62/752,636, filed Oct. 30, 2018, which is hereby incorporated by reference in its entirety.

### BACKGROUND

### 1. Technical Field

The present disclosure relates to the field of user interfaces. More particularly, the present disclosure relates to a method for generating a user interface for facilitating user interaction with an existing application.

### 2. Background Information

When a software developer creates an application, there is a need to build a user interface that enables a user to access and execute the application. Conventionally, the software developer may use a framework such as AngularJS, Flask, React, or Vue to build such a user interface.

However, for a typical user, the process of building a user interface may be time-consuming and cumbersome. In particular, a significant amount of software development time and effort is generally required for creating a user interface, and additional time and effort may then be required in order to obtain a desired aesthetic design, i.e., a preferred “look and feel”. In addition, a particular user interface is generally tailored to a specific application, and therefore, the result of the process is usable only for one application, and each additional application requires a separate build process for a corresponding user interface.

Accordingly, there is a need for a simplified methodology for building a user interface that facilitates access to and use of a particular application and that satisfies user design preferences.

### SUMMARY

The present disclosure, through one or more of its various aspects, embodiments, and specific features or sub-components, provides, inter alia, various systems, servers, devices, methods, media, programs, and platforms for generating a user interface for facilitating user interaction with an existing application.

According to an aspect of the present disclosure, a method for generating a user interface is provided. The method is implemented by at least one processor. The method includes: identifying an application; displaying, to a user, a list of selectable features; receiving, from the user, at least one selection from the list; and generating a user interface based on the identified application and the received at least one selection.

The list of selectable features may include at least one from among a feature that relates to an icon, a feature that relates to a font type, a feature that relates to a font size, and a feature that relates to a color.

The list of selectable features may include at least one from among a home tab, a user interface design tab, a modal button, an email button, an email and password submission button, a file input button, a loading spinner, a loading fidget spinner, an inbox notification, a color-coded message notification, a color-coded success notification, and a checkbox for a predetermined functionality.

The list of selectable features may include at least one programmable coding feature. The at least one programmable coding feature may include at least one from among a list icons feature, a children feature display feature, a matching list items feature, a dynamic screen width feature, a code controller feature, an active function calls feature, a group item reset feature, a dynamic Javascript references feature, a dynamic Cascading Style Sheets references feature, a controller initialization feature, a navigation pane feature, a drop-down menu feature, a user interface container isolation feature, a dynamic header/footer links feature, an invert feature display feature, a dynamic margin/window pane spacing feature, a selectable feature manipulation feature, a user input validation feature, a dynamic window and ribbon tab value feature, an agnostic database connectivity validation feature, a dynamic framework modules feature, and a dynamic framework integration/configuration feature.

The generating the user interface may include interacting with at least one from among AngularJS, Flask, React, and Vue.

The generating the user interface may include performing an Angular JS integration operation, performing a HyperText Markup Language (HTML) instantiation operation, using JavaScript to perform an automatic scripting injection, and performing a style sheet configuration operation.

The method may further include generating an integration platform that facilitates a connection with at least one from among a database, a back-end system, and an external network.

The integration platform may be configured to perform an integration function by using at least one language from among AngularJS, Javascript, Python, Flask, Java, React, eXtensible Markup Language (XML), YAML Aint Markup Language (YML), Cascading Style Sheets (CSS), and HyperText Markup Language (HTML).

The method may further include using the integration platform to perform a feature addition by generating at least one from among a plugin, an extension, and an automatic application integration.

According to another aspect of the present disclosure, a computing apparatus for generating a user interface is provided. The computing apparatus includes a processor, a memory, and a communication interface coupled to each of the processor, the memory, and a display screen. The processor is configured to: identify an application; display, on the display screen, a list of selectable features; receive, via the communication interface, at least one selection from the list; and generate a user interface based on the identified application and the received at least one selection.

The list of selectable features may include at least one from among a feature that relates to an icon, a feature that relates to a font type, a feature that relates to a font size, and a feature that relates to a color.

The list of selectable features may include at least one from among a home tab, a user interface design tab, a modal button, an email button, an email and password submission button, a file input button, a loading spinner, a loading fidget spinner, an inbox notification, a color-coded message notification, a color-coded success notification, and a checkbox for a predetermined functionality.

The list of selectable features may include at least one programmable coding feature. The at least one programmable coding feature may include at least one from among a list icons feature, a children feature display feature, a matching list items feature, a dynamic screen width feature, a code controller feature, an active function calls feature, a group item reset feature, a dynamic Javascript references feature, a dynamic Cascading Style Sheets references feature, a controller initialization feature, a navigation pane feature, a drop-down menu feature, a user interface container isolation feature, a dynamic header/footer links feature, an invert feature display feature, a dynamic margin/window pane spacing feature, a selectable feature manipulation feature, a user input validation feature, a dynamic window and ribbon tab value feature, an agnostic database connectivity validation feature, a dynamic framework modules feature, and a dynamic framework integration/configuration feature.

The processor may be further configured to generate the user interface by interacting with at least one from among AngularJS, Flask, React, and Vue.

The processor may be further configured to generate the user interface by performing an Angular JS integration operation, performing a HyperText Markup Language (HTML) instantiation operation, using JavaScript to perform an automatic scripting injection, and performing a style sheet configuration operation.

The processor may be further configured to generate an integration platform that facilitates a connection with at least one from among a database, a back-end system, and an external network.

The processor may be further configured to use the integration platform to perform an integration function by using at least one language from among AngularJS, Javascript, Python, Flask, Java, React, eXtensible Markup Language (XML), YAML Aint Markup Language (YML), Cascading Style Sheets (CSS), and HyperText Markup Language (HTML).

The processor may be further configured to use using the integration platform to perform a feature addition by generating at least one from among a plugin, an extension, and an automatic application integration.

### BRIEF DESCRIPTION OF THE DRAWINGS

FIG. 1 shows an exemplary general computer system that is configured to implement a method for generating a user interface, according to an exemplary embodiment.

FIG. 2 shows a block diagram of a networked system that includes a client computer that is communicatively connected to at least one server computer via a network, according to an exemplary embodiment.

FIG. 3 shows a flowchart that illustrates a method for generating a user interface, according to an exemplary embodiment.

FIG. 4 shows a screenshot of a design page that facilitates a selection of features to be implemented in conjunction with the method of FIG. 3, according to an exemplary embodiment.

FIG. 5 shows a screenshot of a user interface that is generated by using the method of FIG. 3, according to an exemplary embodiment.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

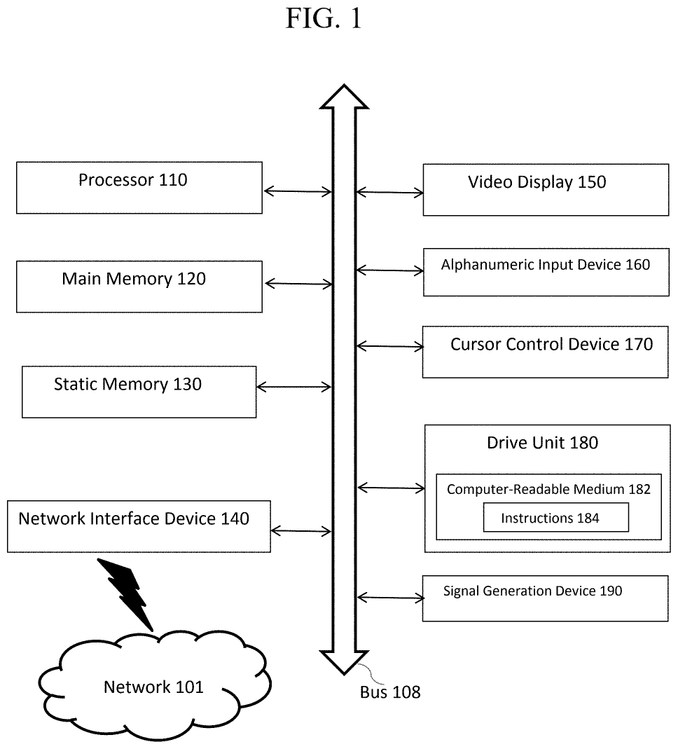

FIG. 1 is an illustrative embodiment of a general computer system, on which a method for building a user interface may be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. Further, the computer system 100 may connect or communicate with other computer systems by near field communications, which includes, without limitation, near field communication (NFC), Bluetooth, radio frequency identification (RFID), or other communication technologies that allow direct communication with another computer system or device.

In a networked deployment, the computer system 100 may operate in the capacity of a server, a client user computer, or any computing device having at least a processor and a memory in a server-client user network environment, or as a peer computer system in a peer-to-peer (or distributed) network environment. The computer system 100 may operate in a network environment including an intermediary device for facilitating transactions with other computer systems, or in a peer-to-peer network environment without the intermediary device. The intermediary device may be a remote third party server residing on a network or a third party device that is not directly involved in a transaction between two computer systems or devices.

The computer system 100 can also be implemented as or incorporated into various devices, such as a stationary computing device, a mobile computer, a wearable computer (e.g., smart watch), a computer system in a vehicle, a personal computer (PC), a laptop computer, a tablet computer, a wireless smart phone, a personal digital assistant (PDA), a communications device, a control system, a network router, switch or bridge, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Further, the computer system 100 may access external memory via a network, such as a cloud network.

Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory (e.g., secure digital (SD) non-volatile memory card), electrically programmable read only memory (EPROM), electrically erasable programmable read-only memory (EEPROM), registers, a hard disk, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted.

As shown, the computer system 100 may further include (or may be connected to) a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. Further, the input device 160 may additionally include a biometric input device, which may capture biometric information of a user. The biometric input device may include, without limitation, a finger print reader, a camera, an iris scanner, a microphone, and any other device that may capture biometric information of the user. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the secondary memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140. The network 101 may be, for example, the Internet.

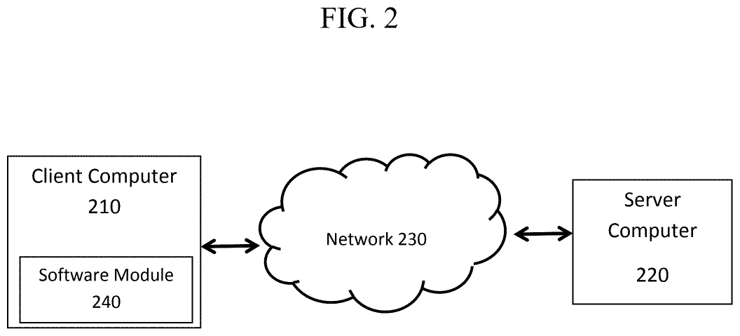

FIG. 2 is a block diagram of a networked system 200 that includes a client computer 210 that is communicatively connected to at least one server computer 220 via a network 230, according to an exemplary embodiment. Referring to FIG. 2, each of client computer 210 and server computer 220 may be equivalent to computer system 100 as illustrated in FIG. 1. Network 230 may include any type of network that implements a communicative connection between client computer 210 and server computer 220, such as, for example, a local area network (LAN), a wide area network (WAN), or the Internet.

The client computer 210 may include a software module 240 that includes instructions that are executable by the client computer 210 to perform a method for generating a user interface, in accordance with an exemplary embodiment. Referring also to FIG. 1, the software module 240 may be provided in conjunction with processor 110. Alternatively, the software module 240 may be stored in any one or more of main memory 120, static memory 130, or computer readable medium 182.

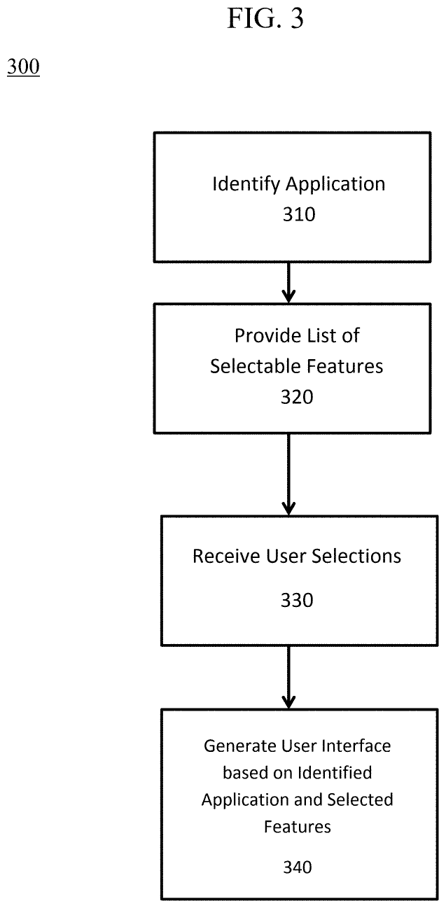

FIG. 3 is a flowchart 300 that illustrates a method for generating a user interface, according to an exemplary embodiment. The method may be implemented, for example, as a set of instructions that are executable by a computer to generate a user interface.

In operation 310, an application is identified by a user as an object with respect to a user interface to be generated. The application may include any type of software application that performs a function that is desired to be executed by the user. The application may be implemented, for example, on any one or more of client computer 210, server computer 220, and/or other computers that are communicatively coupled to client computer 210 via network 230.

In operation 320, a list of selectable features is provided to the user. For example, referring to FIG. 1, the list of selectable features may be presented on video display 150. The list may include any type of feature that relates to the user interface to be generated. For example, the list may include features that relate to icons, font types and sizes, colors, and/or any other type of aesthetic object or quality to be shown on the user interface. The following is an exemplary list of features:
1) Home Tab
2) User Interface Design Tab
3) User Interface Generation Tab
4) List of Ribbon Names
5) List of Icon Names
6) Small Size Modal Button
7) Medium Size Modal Button
8) Large Size Modal Button
9) Example Email Button
10) Email & Password Submission Button
11) File Input Button
12) Hover Over Box
13) List with Bullets
14) List with Numbers
15) Expansion List
16) Loading Spinner
17) Loading Fidget Spinner
18) Inbox Notifications
19) Blue Message Notifications
20) Grey Message Notifications
21) Green Message Notifications
22) Royal Blue Message Notifications
23) Orange Message Notifications
24) Red Message Notifications
25) Email Notification (no word)
26) Email Notification Right
27) Email Notification Bottom
28) List of Review Checkboxes
29) Angular Based Tabs
30) Green Success Notification
31) Red Success. Notification
32) Orange Success Notification
33) Blue Success Notification
34) Error Response (e.g., 404 Response)
35) Clickable Link for Updates
36) Clickable Link for Confluence Page
37) Checkbox for Blank Home Page
38) Checkbox for not downloading Base AngularJS Files
39) Checkbox for Blank files without AngularJS integration
40) Checkbox for Javascript file for User Modification
41) Checkbox for not downloading AngularJS controllers
42) Hover Over Box
43) Checkbox for downloading Flask Files
44) Checkbox for not-downloading Flask Files
45) Option to leverage Flask Route Endpoint Capabilities
46) Option to leverage Flask templates
47) Optional addition to include initialization files
48) Click-To-Add import functionality to each Flask Module
49) Adaptive export files based on User Access

In addition, the list of features is presented in a manner that enables the user to select the desired features, and the user selections of features are received in operation 330. For example, a button may be provided with each feature, so that when the user uses a cursor control device 170 (see FIG. 1) to click on the button that is associated with a particular feature, the particular feature is selected. Further, the button may then enable the user to deselect the feature, so that if a user selects a particular feature but subsequently decides not to include the particular feature, the particular feature may be deselected. As another example, a checkbox may be provided with each respective feature, so that when the user clicks on the checkbox, a check mark or an “X” may be shown to illustrate that the corresponding feature has been selected; and a subsequent click on the marked checkbox would then have the effect of deselecting the feature.

In an exemplary embodiment, the list of features may further include a list of programmable coding features that are intended to provide a user with an enhanced capability to customize the user interface. The following is an exemplary list of programmable coding features:
1) List Icons
2) Children Feature Display
3) Matching List Items
4) Dynamic Screen Width
5) Code Controller
6) Active Function Calls
7) Group Item Reset
8) Dynamic Javascript References
9) Dynamic Cascading Style Sheets References
10) Controller Initialization
11) Navigation Pane
12) Drop-Down Menu
13) User Interface Container Isolation
14) Dynamic Header/Footer Links
15) Invert Feature Display
16) Dynamic Margin/Window Pane Spacing
17) Selectable Feature Manipulation
18) User Input Validation
19) Dynamic Window and Ribbon Tab Value
20) Agnostic Database Connectivity Validation
21) Dynamic Framework Modules
22) Dynamic Framework Integration/Configuration

In operation 340, a user interface is generated based on the identified application and the selected features. In particular, referring to FIG. 2, the software module 240 may include instructions that, when executed, determine respective functionalities of the application identified in operation 310 to be included in the user interface, and then build the user interface based on the features selected by the user as a result of operations 320 and 330. In an exemplary embodiment, the software module 240 includes instructions that facilitate an interaction with a web application framework such as, for example, AngularJS, Flask, React, or Vue, in order to build the user interface. Further, the software module 240 creates programming logic and implements the logic to the user interface, thereby enabling user interaction and feature manipulation.

In an exemplary embodiment, the user interface is automatically generated by performing an AngularJS or Flask integration operation, a HyperText Markup Language (HTML) instantiation operation, automatic scripting injection with JavaScript, and a style sheet configuration operation. As a result of these operations, files that are necessary for database connectivity may be created, and automatic code configuration prior to database integration may be performed.

Further, command logic is generated and integrated into the user interface, thereby providing the user with an integration platform in order to facilitate a connection with a database, back-end system, or network, and the integration platform is completely coding-language agnostic; i.e., presented to the user in a user-friendly format that does not rely on the user's abilities with respect to a coding language. In an exemplary embodiment, the integration platform may be used for facilitating feature additions with respect to the user interface, such as, for example, a plugin, an extension, and/or an automatic application integration. In an exemplary embodiment, the integration platform may perform integration functions by using at least one of the following languages: Angular JS, Javascript, Python, Flask, Java, React, Extensible Markup Language (XML), YAML Ain't Markup Language (YML), Cascading Style Sheets (CSS), and HyperText Markup Language (HTML).

In an exemplary embodiment, an instruction guide for generating a user interface may indicate that the generation of the user interface uses AngularJS, HTML, and standard Javascript. A home page may include a link to a set of design principles, a confluence page that includes a “read-me” file, files for downloading if a complete user interface is not preferred, and a design tab that enables a user to proceed to a design page.

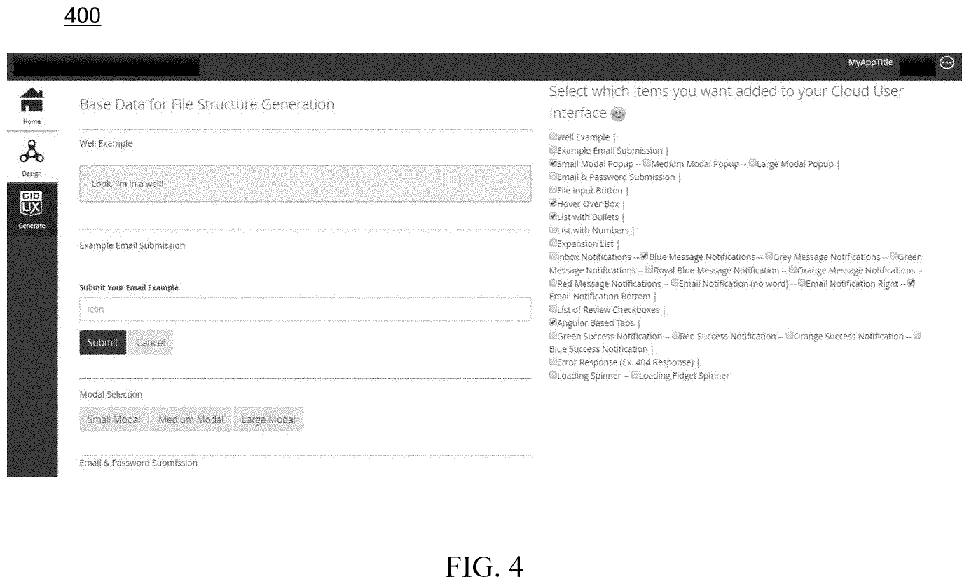

Referring to FIG. 4, in an exemplary embodiment, the design page 400 facilitates a selection of features that will be generated and integrated into the HTML and Javascript files embedded within a necessary set of AngularJS components. For example, a user may select a small modal design, a medium modal design, or a large modal design, such that the selected mode specifies a size of a feature. Other features are listed and are selectable by a user. Then, a user may be prompted to input ribbon names and icon names to be included in the user interface.

In an exemplary embodiment, a user may be prompted to provide inputs with respect to checkboxes that correspond to generation parameters. For example, a first checkbox may relate to generating a blank AngularJS htm file with full customization; a second checkbox may relate to preventing a Base AngularJS zip file from downloading; and a third checkbox may relate to preventing an AngularJS integration and providing absolute base files that are necessary for a user interface based on CloudUX principles. The user may then be prompted to click a button to initiate the generation of the user interface.

In an exemplary embodiment, the user may then be prompted to create and/or rename htm files, and then to cut and paste in order to separate out which newly generated features belong with which htm files. The modified files are then used to replace the corresponding files in a folder structure that had previously been generated for a different user interface.

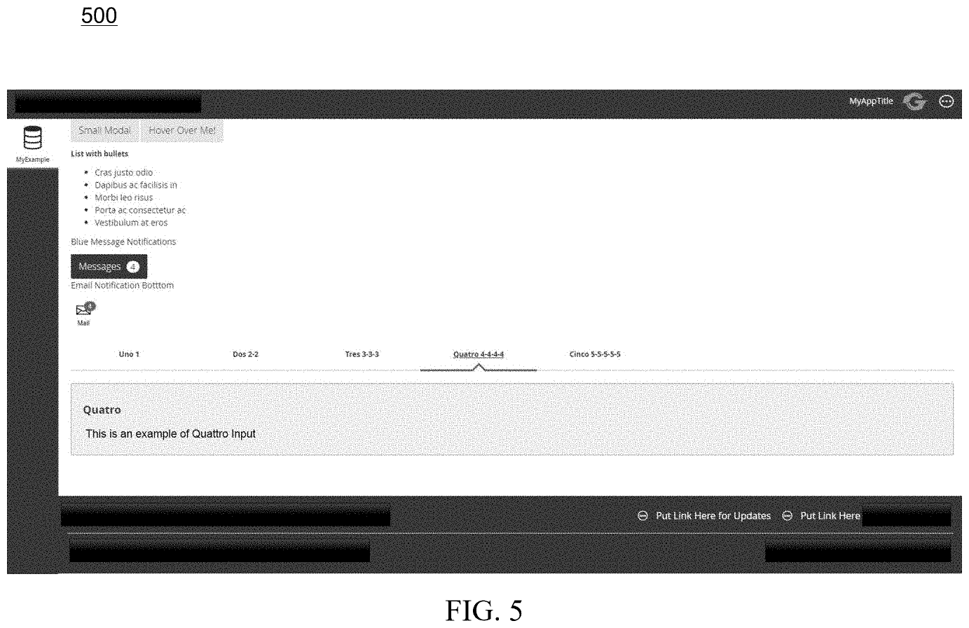

FIG. 5 shows a screenshot of a user interface 500 that is generated by using the method of FIG. 3, according to an exemplary embodiment. In the example illustrated in FIG. 5, the user identified application is a statement of “This is an example of Quattro input”, and the features selected by the user include a banner that has a space for a company affiliation and a title; a ribbon that includes a “MyExample” icon; a small size modal button; a hover over me button; a list with bullets; blue message notifications; email notification bottom; a clickable link for updates; a clickable link for a confluence page; and a designated space for version numbers and application icons.

Once the application has been identified and the features have been selected, the user interface is automatically generated. As shown in FIG. 5, for example, the user interface enables the user to interact by providing various areas on the screen that prompt the user to provide an input, thereby facilitating the user interaction and executing the application in accordance with the user interaction. Further, as also shown in FIG. 5, the user interface includes several features that implement aesthetic and/or design attributes in accordance with user preferences.

Accordingly, with this technology, an optimized process for implementing methods and systems for generating a user interface for facilitating a user capability to access and execute an application such that the user interface includes user-selected features in accordance with a preferred aesthetic design is provided.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to an aspect of the present disclosure, a system and method is provided for generating a user interface for facilitating a user capability to access and execute an application, such that the user interface includes user-selected features in accordance with a preferred aesthetic design.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person ordinarily skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating a user interface, comprising:
identifying, by a processor, an application;
displaying, by the processor to a user, a list of selectable features;
receiving, by the processor from the user, at least one selection from the list; and
generating, by the processor, a user interface based on the identified application and the received at least one selection.

2. The method of claim 1, wherein the list of selectable features includes at least one from among a feature that relates to an icon, a feature that relates to a font type, a feature that relates to a font size, and a feature that relates to a color.

3. The method of claim 1, wherein the list of selectable features includes at least one from among a home tab, a user interface design tab, a modal button, an email button, an email and password submission button, a file input button, a loading spinner, a loading fidget spinner, an inbox notification, a color-coded message notification, a color-coded success notification, and a checkbox for a predetermined functionality.

4. The method of claim 1, wherein the list of selectable features includes at least one programmable coding feature.

5. The method of claim 4, wherein the at least one programmable coding feature includes at least one from among a list icons feature, a children feature display feature, a matching list items feature, a dynamic screen width feature, a code controller feature, an active function calls feature, a group item reset feature, a dynamic Javascript references feature, a dynamic Cascading Style Sheets references feature, a controller initialization feature, a navigation pane feature, a drop-down menu feature, a user interface container isolation feature, a dynamic header/footer links feature, an invert feature display feature, a dynamic margin/window pane spacing feature, a selectable feature manipulation feature, a user input validation feature, a dynamic window and ribbon tab value feature, an agnostic database connectivity validation feature, a dynamic framework modules feature, and a dynamic framework integration/configuration feature.

6. The method of claim 1, wherein the generating the user interface comprises interacting with at least one from among AngularJS, Flask, React, and Vue.

7. The method of claim 1, wherein the generating the user interface comprises performing an Angular JS integration operation, performing a HyperText Markup Language (HTML) instantiation operation, using JavaScript to perform an automatic scripting injection, and performing a style sheet configuration operation.

8. The method of claim 1, further comprising generating an integration platform that facilitates a connection with at least one from among a database, a back-end system, and an external network.

9. The method of claim 8, wherein the integration platform is configured to perform an integration function by using at least one language from among AngularJS, Javascript, Python, Flask, Java, React, eXtensible Markup Language (XML), YAML Aint Markup Language (YML), Cascading Style Sheets (CSS), and HyperText Markup Language (HTML).

10. The method of claim 8, further comprising using the integration platform to perform a feature addition by generating at least one from among a plugin, an extension, and an automatic application integration.

11. A computing apparatus for generating a user interface, the computing apparatus comprising:
a processor;
a memory; and
a communication interface coupled to each of the processor, the memory, and a display screen,
wherein the processor is configured to:
identify an application;
display, on the display screen, a list of selectable features;
receive, via the communication interface, at least one selection from the list; and
generate a user interface based on the identified application and the received at least one selection.

12. The computing apparatus of claim 11, wherein the list of selectable features includes at least one from among a feature that relates to an icon, a feature that relates to a font type, a feature that relates to a font size, and a feature that relates to a color.

13. The computing apparatus of claim 11, wherein the list of selectable features includes at least one from among a home tab, a user interface design tab, a modal button, an email button, an email and password submission button, a file input button, a loading spinner, a loading fidget spinner, an inbox notification, a color-coded message notification, a color-coded success notification, and a checkbox for a predetermined functionality.

14. The computing apparatus of claim 11, wherein the list of selectable features includes at least one programmable coding feature.

15. The computing apparatus of claim 14, wherein the at least one programmable coding feature includes at least one from among a list icons feature, a children feature display feature, a matching list items feature, a dynamic screen width feature, a code controller feature, an active function calls feature, a group item reset feature, a dynamic Javascript references feature, a dynamic Cascading Style Sheets references feature, a controller initialization feature, a navigation pane feature, a drop-down menu feature, a user interface container isolation feature, a dynamic header/footer links feature, an invert feature display feature, a dynamic margin/window pane spacing feature, a selectable feature manipulation feature, a user input validation feature, a dynamic window and ribbon tab value feature, an agnostic database connectivity validation feature, a dynamic framework modules feature, and adynamic framework integration/configuration feature.

16. The computing apparatus of claim 11, wherein the processor is further configured to generate the user interface by interacting with at least one from among AngularJS, Flask, React, and Vue.

17. The computing apparatus of claim 11, wherein the processor is further configured to generate the user interface by performing an Angular JS integration operation, performing a HyperText Markup Language (HTML) instantiation operation, using JavaScript to perform an automatic scripting injection, and performing a style sheet configuration operation.

18. The computing apparatus of claim 11, wherein the processor is further configured to generate an integration platform that facilitates a connection with at least one from among a database, a back-end system, and an external network.

19. The computing apparatus of claim 18, wherein the processor is further configured to use the integration platform to perform an integration function by using at least one language from among AngularJS, Javascript, Python, Flask, Java, React, eXtensible Markup Language (XML), YAML Aint Markup Language (YML), Cascading Style Sheets (CSS), and HyperText Markup Language (HTML).

20. The computing apparatus of claim 18, wherein the processor is further configured to use using the integration platform to perform a feature addition by generating at least one from among a plugin, an extension, and an automatic application integration.
